(19) United States
(12) Patent Application Publication
(10) Pub. No.: US 2024/0170024 A1
(43) Pub. Date: May 23, 2024

(54) INFORMATION PROCESSING APPARATUS, INFORMATION PROCESSING METHOD, AND NON-TRANSITORY COMPUTER-READABLE STORAGE MEDIUM

(71) Applicant: SONY GROUP CORPORATION, TOKYO (JP)

(72) Inventors: FUMIHIKO IIDA, TOKYO (JP); KENTA ABE, TOKYO (JP); YUJI KITAZAWA, TOKYO (JP)

(21) Appl. No.: 18/551,468

(22) PCT Filed: Mar. 9, 2022
(86) PCT No.: PCT/JP2022/010164

§ 371 Date: Sep. 20, 2023

(30) Foreign Application Priority Data
Mar. 31, 2021 (JP) 2021-062192

(51) Int. Cl. G11B 27/031; G11B 27/34

(52) U.S. Cl. CPC G11B 27/031; G11B 27/34

(57) ABSTRACT

Information processing apparatus (100) includes an output unit (130) that outputs reference camera switching information for continuously reproducing a first moving image obtained by capturing an image of a first target by a first camera and a second moving image obtained by capturing an image of a second target related to the first target by a second camera different from the first camera according to an input operation of a user input by the user.

### FIELD

The present invention relates to information processing apparatus, an information processing method, and a non-transitory computer-readable storage medium.

### BACKGROUND

In the related art, a technology related to a moving image editing service that supports generation of a moving image (also referred to as a video) edited by a camera work or switching desired by a user is known. For example, there is known a technique of generating a camera work for a CG object by changing a camera parameter of a camera corresponding to a viewpoint representing from which position and how to view the CG object according to an artist name, a genre, a tempo, and the like of music data.

### CITATION LIST

### Patent Literature

Patent Literature 1: JP 2005-56101 A

### SUMMARY

### Technical Problem

However, in the above-described technology in the related art, only the camera work is generated according to an artist name, a genre, a tempo, and the like of music data, and usability in a moving image editing service cannot be necessarily improved.

Therefore, the present disclosure proposes information processing apparatus, an information processing method, and a non-transitory computer-readable storage medium capable of improving usability in a moving image editing service.

### Solution to Problem

According to the present disclosure, an information processing apparatus is provided that includes: an output unit that outputs reference camera switching information for continuously reproducing a first moving image obtained by capturing an image of a first target by a first camera and a second moving image obtained by capturing an image of a second target related to the first target by a second camera different from the first camera according to an input operation of a user.

### BRIEF DESCRIPTION OF DRAWINGS

FIG. 1 is a diagram illustrating a configuration example of an information processing system according to an embodiment of the present disclosure.

FIG. 2 is a diagram illustrating a configuration example of information processing apparatus according to the embodiment.

FIG. 3 is a diagram illustrating an example of an input operation of a section of moving image information by a user according to the embodiment.

FIG. 4 is a diagram illustrating an example of the input operation of the section of the moving image information by the user according to the embodiment.

FIG. 5 is a diagram illustrating an example of a summary table of metadata associated with the section of the moving image information input by the user according to the embodiment.

FIG. 6 is a diagram illustrating an example of reference camera switching information according to the embodiment.

FIG. 7 is a flowchart illustrating an example of determination processing of determining a level of compatibility between reference camera switching information and an editing target moving image according to the embodiment.

FIG. 8 is a diagram illustrating an example of camera work information related to an editing target moving image according to the embodiment.

FIG. 9 is a diagram illustrating an example of a screen of a user interface that displays an edited moving image according to the embodiment.

FIG. 10 is a diagram illustrating an example of a screen of a user interface for editing the edited moving image according to the embodiment.

FIG. 11 is a diagram illustrating an example of a screen of a user interface for sharing the edited moving image according to the embodiment with another user.

FIG. 12 is a flowchart illustrating an example of information processing by the information processing apparatus according to the embodiment.

FIG. 13 is a hardware configuration diagram illustrating an example of a computer that realizes functions of the information processing apparatus.

### DESCRIPTION OF EMBODIMENTS

Hereinafter, embodiments of the present disclosure are described in detail based on the accompanying drawings. In each of the following embodiments, the same parts are denoted by the same reference numerals, and redundant description will be omitted.

### Embodiment

[1. Introduction]

In recent years, in the field of video distribution, multiview distribution in which a plurality of images is distributed and a user selects a screen, and distribution in a free viewpoint video in which a user can freely switch viewpoints in a video space generated from videos photographed by a plurality of cameras are spreading. These video distributions can provide a new viewing experience in that the user can select a video that the user wants to view, but there is a problem that the user needs to select a video or a viewpoint according to his/her preference during viewing, and the user cannot concentrate on viewing a video that the user originally wants to enjoy.

As a technique of automatically switching from the plurality of videos, there are known a technique of combining manual or face recognition techniques to select a video in which a person appears from a plurality of videos and a technique of generating the camera work for a three-dimensional model. However, in these conventional techniques, when there are images photographed by a plurality of cameras for the same sound source like a music live show, it is not possible to deal with the problem which image is to be selected. In addition, the switching using only the result of the face recognition cannot ensure the quality of the video experience.

Meanwhile, information processing apparatus 100 according to the embodiment of the present disclosure outputs reference camera switching information for continuously reproducing a first moving image obtained by capturing an image of a first target by the first camera and a second moving image obtained by capturing an image of a second target related to the first target by a second camera different from the first camera according to an input operation of a user input by the user.

In this manner, the information processing apparatus 100 generates the reference camera switching information based on the camera work that suits the user's own taste selected in advance from the video content viewed by the user in the past. As a result, even when there are images photographed by a plurality of cameras with respect to the same sound source like a music live show, the information processing apparatus 100 can appropriately select an image of a camera that suits the preference of the user based on the reference camera switching information from among the images photographed by the plurality of cameras. Furthermore, the information processing apparatus 100 can edit video according to the reference camera switching information when the user views new video content. Therefore, the information processing apparatus 100 can generate a video that suits the preference of the user without disturbing the video experience of the user. That is, the information processing apparatus 100 can improve usability in the moving image editing service.

[2. Configuration of Information Processing System]

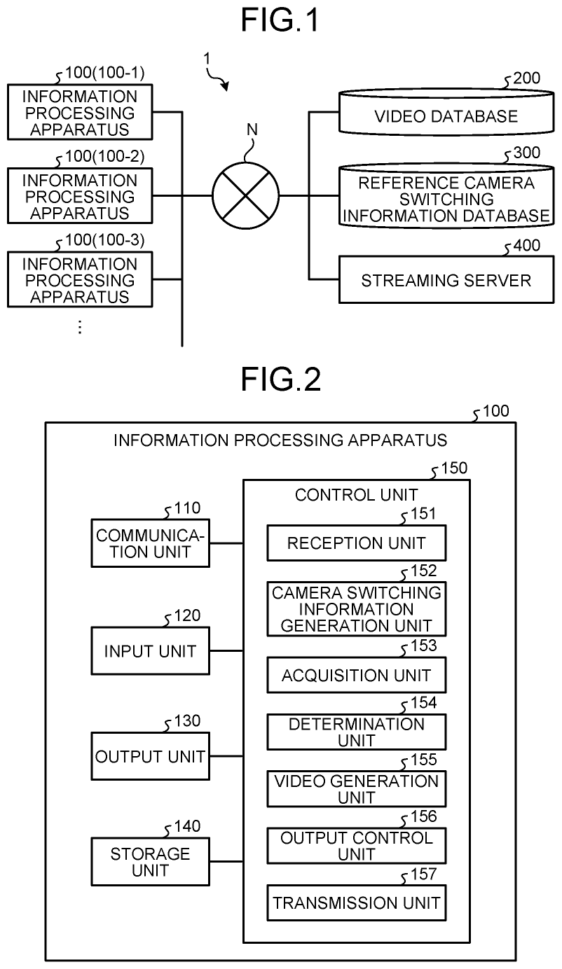

FIG. 1 is a diagram illustrating a configuration example of an information processing system 1 according to the embodiment of the present disclosure. The information processing system 1 includes the information processing apparatus 100, a video database 200, a reference camera switching information database 300, and a streaming server 400. The information processing apparatus 100, the video database 200, the reference camera switching information database 300, and the streaming server 400 are communicably connected by wire or wirelessly via a predetermined network N. Note that the information processing system 1 illustrated in FIG. 1 may include any number of items of information processing apparatus 100, any number of the video databases 200, any number of the reference camera switching information databases 300, and any number of the streaming servers 400.

The information processing apparatus 100 is an information processing apparatus used by a user of a moving image editing service. The information processing apparatus 100 is implemented by, for example, a smartphone, a tablet terminal, a notebook personal computer (PC), a desktop PC, a mobile phone, a personal digital assistant (PDA), or the like.

Hereinafter, a user specified by a user ID “U1” may be referred to as a “user U1”. As described above, in the following description, when a “user U* (* is any numerical value)” is described, it is indicated that the user is a user specified by a user ID “U*”. For example, when a “user U2” is described, the user is a user specified by a user ID “U2”.

Furthermore, hereinafter, the information processing apparatus 100 is described as information processing apparatus 100-1 and 100-2 according to the users who use the information processing apparatus 100. For example, the information processing apparatus 100-1 is the information processing apparatus 100 used by the user U1. In addition, the information processing apparatus 100-2 is the information processing apparatus 100 used by the user U2. Furthermore, in the following, the information processing apparatus 100-1 and 100-2 are referred to as the information processing apparatus 100 when the apparatus is not particularly distinguished from each other.

The video database 200 is a database that stores moving image information (such as video content) in the past.

The reference camera switching information database 300 is a database that stores metadata related to a moving image described below, reference camera switching information generated by a user, and an edited moving image edited based on the reference camera switching information.

The streaming server 400 is information processing apparatus that captures and collects moving images when live distribution or the like is performed in real time. The streaming server 400 performs streaming distribution of a moving image.

[3. Configuration of Information Processing Apparatus]

FIG. 2 is a diagram illustrating a configuration example of the information processing apparatus 100 according to the embodiment of the present disclosure. As illustrated in FIG. 2, the information processing apparatus 100 includes a communication unit 110, an input unit 120, an output unit 130, a storage unit 140, and a control unit 150.

(Communication Unit 110)

The communication unit 110 is implemented by, for example, a network interface card (NIC) or the like. Furthermore, the communication unit 110 is connected to the network N by wired or wirelessly and transmits and receives information, for example, to and from the video database 200, the reference camera switching information database 300, and the streaming server 400.

(Input Unit 120)

The input unit 120 receives various input operations from the user. The input unit 120 is implemented by a keyboard or a mouse. As the device of the input unit 120, a device incorporated in the information processing apparatus 100 may be used. For example, in the case of a smartphone, the device is a touch panel, a microphone, or the like. Furthermore, the input unit 120 may include information input using a camera.

(Output Unit 130)

The output unit 130 displays various types of information. The output unit 130 is implemented by, for example, a liquid crystal display, an organic electro-luminescence (EL) display, or the like. For example, the output unit 130 displays moving image information viewed by the user. In addition, the output unit 130 displays the reference camera switching information generated by a camera switching information generation unit 152. Furthermore, the output unit 130 displays an editing target moving image to be edited. In addition, the output unit 130 displays the edited moving image edited based on the reference camera switching information. Note that, hereinafter, the output unit 130 may be referred to as a “screen”.

(Storage Unit 140)

The storage unit 140 is implemented by, for example, a semiconductor memory element such as a random access memory (RAM) or a flash memory or a storage device such as a hard disk or an optical disk. For example, the storage unit 140 stores moving image information viewed by the user, reference camera switching information, an editing target moving image, and an edited moving image.

(Control Unit 150)

Referring back to FIG. 2, the description is continued. The control unit 150 is a controller and is implemented by, for example, a central processing unit (CPU), a micro processing unit (MPU), an application specific integrated circuit (ASIC), a field programmable gate array (FPGA), or the like executing various programs (corresponding to an example of an information processing program) stored in a storage device inside the information processing apparatus 100 using a storage area such as a RAM as a work area. In the example illustrated in FIG. 2, the control unit 150 includes a reception unit 151, the camera switching information generation unit 152, an acquisition unit 153, a determination unit 154, a video generation unit 155, and a transmission unit 157.

(Reception Unit 151)

The reception unit 151 receives an input operation of a section (including a time point) of the moving image information from the user. Specifically, the reception unit 151 receives an input operation of a section (section liked by the user) that matches the user's own taste in the moving image information. Here, the moving image information according to the present embodiment includes information related to a moving image edited so that a first moving image obtained by capturing an image of a first target by a first camera and a second moving image obtained by capturing an image of a second target related to the first target by a second camera different from the first camera are continuously reproduced. In other words, the moving image information according to the present embodiment includes information related to a moving image subjected to editing in which images photographed by a plurality of different cameras are switched (for example, switching of the camera). Note that, hereinafter, a moving image that has been edited or a moving image subjected to editing may be referred to as an “edit moving image”. Furthermore, hereinafter, information related to the edit moving image may be referred to as “edit moving image information”.

For example, the reception unit 151 receives an operation of setting a tag in a section matching the user's own taste from the user who is viewing the moving image information. Furthermore, the reception unit 151 may receive an input operation of a time point when the user feels particularly good in the moving image information.

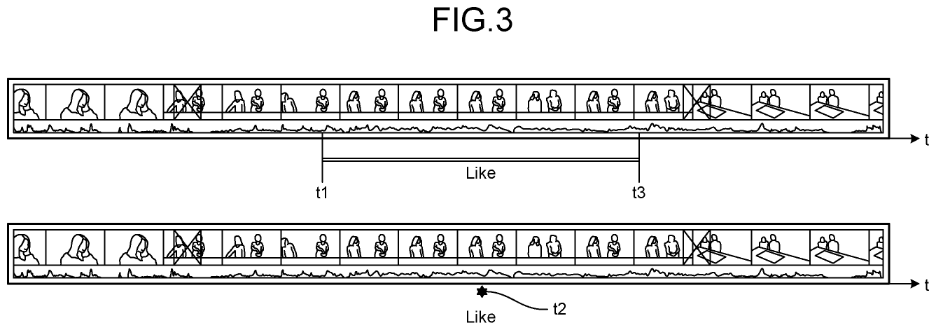

FIG. 3 is a diagram of illustrating an example of the input operation of the section of the moving image information by the user according to the embodiment of the present disclosure. In the example illustrated in the lower part of FIG. 3, the reception unit 151 receives an operation of setting a flag on the moving image information at time t2 at the time point when the user feels particularly good from the user who is viewing the moving image information. For example, the output unit 130 displays a “Like” button on a screen on which the moving image information is being displayed. Then, the reception unit 151 receives an operation of selecting the “Like” button displayed on the screen on which the moving image information is being displayed as the operation of setting the flag.

In addition, when receiving the operation of setting the flag, the reception unit 151 may set buffer time before and after the time point when the user performs the input. That is, the reception unit 151 receives the section of the buffer time including the time point when the user performs the input as the section of the moving image information input by the user. The buffer time may be a fixed value or may be a timing of switching the camera by checking a change status of switching the camera. In the example illustrated in the upper part of FIG. 3, the reception unit 151 sets the buffer time before and after the time t2 at the time when the user performs the input. That is, the reception unit 151 receives an input operation of a section from time t1 before the time t2 input by the user to time t3 after the time t2 input by the user.

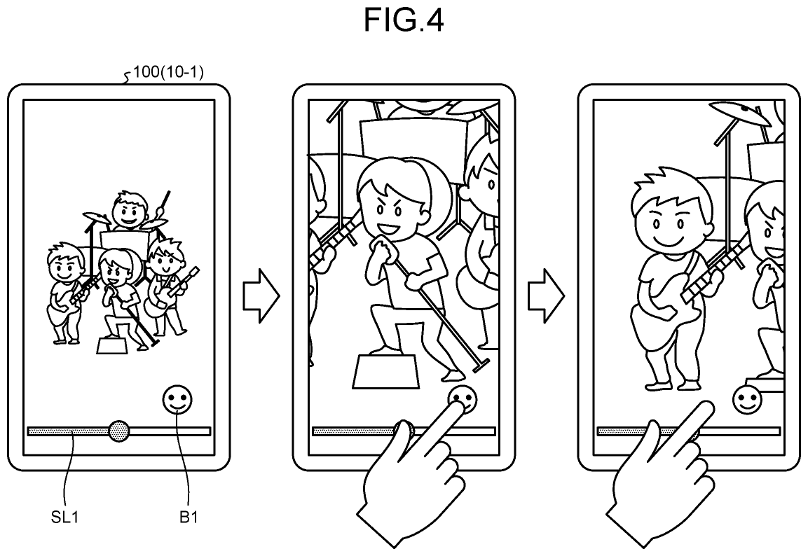

FIG. 4 is a diagram illustrating an example of the input operation of the section of the moving image information by the user according to the embodiment of the present disclosure. In the example illustrated in FIG. 4, the output unit 130 displays a “Favorite” button B1 on the screen on which the moving image information is being displayed. Then, the reception unit 151 receives an operation of selecting the “Favorite” button B1 displayed on the screen on which the moving image information is being displayed from the user who is viewing the moving image information. For example, the reception unit 151 receives an operation in which the user taps the “Favorite” button B1 displayed on the screen with a finger.

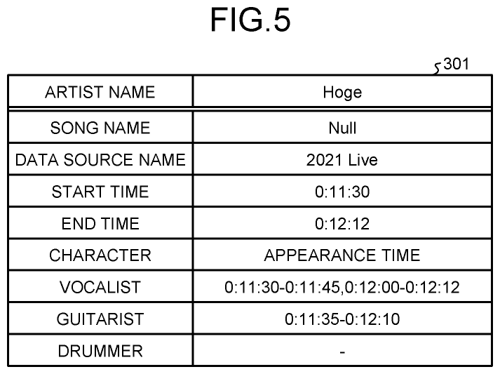

Further, when receiving an input operation of a section of the moving image information from the user, the reception unit 151 extracts metadata associated with the section (hereinafter, also referred to as an input section) of the moving image information input by the user. FIG. 5 is a diagram illustrating an example of a summary table of metadata associated with the section of the moving image information input by the user according to the embodiment of the present disclosure. In the example illustrated in FIG. 5, the reception unit 151 extracts an artist name, a song name, a name of a source (data source) of moving image information associated with the input section, and a start time and an end time of the input section as metadata. Subsequently, the reception unit 151 generates a summary table 301 including the extracted metadata.

Further, when receiving an input operation of a section of the moving image information from the user, the reception unit 151 performs image analysis on the input section. For example, the reception unit 151 performs image analysis on the input section to determine the characters appearing in the input section and appearance times of the characters. In the example illustrated in FIG. 5, the reception unit 151 determines that each of the vocalist and the guitarist of the band as the characters appears at each appearance time shown in the summary table 301. In this manner, the reception unit 151 generates the summary table 301 of the metadata including the photographing target (in the example of FIG. 5, the characters) included in the moving image information of the section input by the user and the appearance time of the photographing target. When generating the summary table 301, the reception unit 151 stores summary table information related to the generated summary table 301 in the storage unit 140.

Note that, in FIG. 5, an example has been described in which the reception unit 151 performs image analysis on the input section to determine the characters appearing in the input section and appearance times of the characters, but the image analysis target is not limited to the characters. For example, the reception unit 151 may perform image analysis on the input section to determine a photographing target (may be, for example, an object, a special effect on the site, or superimposed information) other than a person appearing in the input section and a photographing time when the photographing target is photographed.

(Camera Switching Information Generation Unit 152)

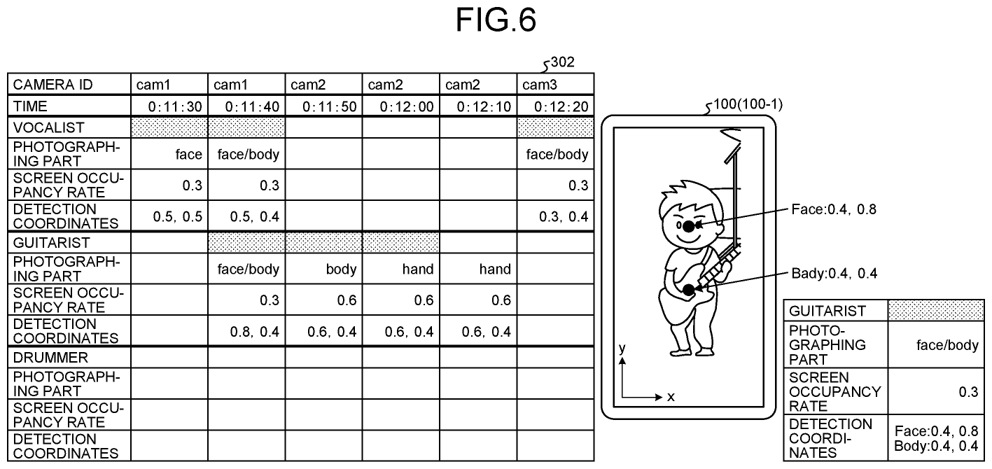

The camera switching information generation unit 152 generates the reference camera switching information based on the information related to the input section. Here, the reference camera switching information is information for continuously reproducing a first moving image obtained by capturing an image of a first target by a first camera and a second moving image obtained by capturing an image of a second target related to the first target by a second camera different from the first camera according to an input operation of the user. The reference camera switching information includes not only information related to switching of the plurality of cameras but also camera identification information for identifying the cameras, time information of the input section input by the user, and target information related to the photographing target. For example, the reference camera switching information includes, as an example of target information, target identification information for identifying a photographing target and information related to position coordinates of the photographing target in an angle of view for each appearance time, an occupied area of the photographing target, and position coordinates of each part of the photographing target for each appearance time. FIG. 6 is a diagram illustrating an example of reference camera switching information according to the embodiment of the present disclosure. In the example illustrated in FIG. 6, the camera switching information generation unit 152 generates, as the reference camera switching information, a table 302 that is information indicating a pattern of time transition of target information that is information related to the camera work and the photographing target (in the example illustrated in FIG. 6, the characters) in the input section. Cells filled with black dot patterns shown in the table 302 indicate that a character corresponding to the time in the input section has appeared.

A pattern of time transitions of the camera work and the characters shown in the table 302 of FIG. 6 is as follows. First, between the time “0:11:30” and the time “0:11:50” of the input section, it is indicated that the videos of “Vocalist” and “Guitarist” are photographed following the video of “Vocalist”, who is the character, by the camera identified by “Cam 1”. Next, between the time “0:11:50” and the time “0:12:20”, it is indicated that a video of “Guitarist” is continuously photographed following the video of “Guitarist” who is the character by the camera identified by “Cam 2”. Next, between the time “0:12:20” and the time “0:12:30”, it is indicated that a video of “Vocalist” who is the character is photographed by the camera identified by “Cam 3”.

Specifically, the camera switching information generation unit 152 performs image analysis on the input section to determine the pattern of the time transition of the camera work in the input section. More specifically, the camera switching information generation unit 152 performs image analysis on the input section to determine whether the video in the input section is continuous. For example, when determining that the video in the input section is not continuous (there is a discontinuous portion), the camera switching information generation unit 152 determines that the change of the camera (that is, switching of the camera) has occurred in the discontinuous portion. That is, when determining that the video in the input section is not continuous (there is a discontinuous portion), the camera switching information generation unit 152 determines that the input section is edit moving image information that is edited so that two or more pieces of different moving image information continuously photographed by two or more different cameras are connected and continuously reproduced. Meanwhile, when determining that the video in the input section is continuous (there is not a discontinuous portion), the camera switching information generation unit 152 determines that the change of the camera (that is, switching of the camera) has not occurred while the video in the input section is photographed. That is, when determining that the video in the input section is continuous (there is not a discontinuous portion), the camera switching information generation unit 152 determines that the input section is one piece of moving image information continuously photographed by one camera. In addition, even when there is continuity as a performance side, a camera may be separately embedded in order to change the classification. In addition, when the instantaneous screen changes due to a special effect or the like, time buffer or manual correction may be performed so that it is determined that there is continuity before and after the change.

In the example of the table 302 illustrated in FIG. 6, the camera switching information generation unit 152 performs image analysis on the input section and determines that there is a discontinuous portion between the time “0:11:50” and the time “0:12:20” of the input section. In addition, since the camera switching information generation unit 152 determines that there is a discontinuous portion between the time “0:11:50” and the time “0:12:20” of the input section, it is determined that the change of the camera (that is, switching of the camera) has occurred at the time “0:11:50” and the time “0:12:20” of the input section. That is, the camera switching information generation unit 152 determines that the input section is the edit moving image information that is edited such that three pieces of different moving image information continuously photographed by three different cameras are connected and continuously reproduced.

The camera ID in the table 302 shown in FIG. 6 indicates camera identification information for identifying the camera when the camera switching information generation unit 152 determines that the camera is switched. For example, the camera switching information generation unit 152 determines that moving image information is continuously photographed by a certain camera from the time “0:11:30” to the time “0:11:50” in the input section. Subsequently, the camera switching information generation unit 152 generates information in which the photographing time from the time “0:11:30” to the time “0:11:50” in the input section is associated with the camera ID “cam 1” for identifying the certain camera.

In addition, the camera switching information generation unit 152 determines that, from the time “0:11:50” to the time “0:12:20” in the input section, the moving image information is continuously photographed by another camera different from the camera identified by the camera ID “cam 1”. Subsequently, the camera switching information generation unit 152 generates information in which the photographing time from the time “0:11:50” to the time “0:12:20” in the input section is associated with the camera ID “cam 2” for identifying the another camera.

In addition, the camera switching information generation unit 152 determines that the moving image information is continuously photographed by still another camera different from the camera identified by the camera ID “cam 2” from the time “0:12:20” to the time “0:12:30” of the input section. Subsequently, the camera switching information generation unit 152 generates information in which the photographing time from the time “0:12:20” to the time “0:12:30” in the input section is associated with the camera ID of “cam 3” for identifying the still another camera.

In this manner, the camera switching information generation unit 152 generates information in which information obtained by associating the camera identification information (in the example illustrated in FIG. 6, “camera ID” in the table 302) capable of identifying each of the two or more different cameras and the photographing time information (in the example illustrated in FIG. 6, “time” in the table 302) indicating the photographing time at which each of the two or more items of different moving image information is photographed by each of the two or more different cameras is arranged in time series.

In addition, the camera switching information generation unit 152 performs image analysis on the input section to determine the pattern of the time transition of the target information related to the photographing target (in the example illustrated in FIG. 6, the characters) in the input section. For example, the camera switching information generation unit 152 refers to the storage unit 140 to acquire summary table information related to the summary table 301. Subsequently, the camera switching information generation unit 152 acquires information related to characters appearing in the input section and appearance times of the characters based on the summary table information. In addition, in general, even in a state of the same appearance, the value as the video representation is different between the drawing and the zooming. Therefore, as an example of the target information, the reference camera switching information generation unit 152 estimates the position coordinates of the characters in the angle of view and the occupied area of the characters for each appearance time by image recognition on the input section. In addition, the camera switching information generation unit 152 detects the coordinates of each part of the characters appearing in the input section for each appearance time using a technology of face recognition or posture estimation as an example of the target information.

In this manner, the camera switching information generation unit 152 acquires, as the target information, target identification information (in the example shown in FIG. 6, the names of the characters such as “Vocalist” and “Guitarist” in the table 302) capable of identifying a photographing target, part identification information (in the example illustrated in FIG. 6, a “photographing part” in the table 302) capable of identifying a photographing part of the photographing target, part position coordinate information (in the example illustrated in FIG. 6, “detection coordinates” in the table 302 and “detection coordinates” in the lower right table) indicating position coordinates of the photographing part with respect to a photographing screen, and information indicating a screen occupancy rate (in the example illustrated in FIG. 6, a “screen occupancy rate” in the table 302) indicating a ratio of an area occupied by the photographing target with respect to the photographing screen, for each appearance time (in the example illustrated in FIG. 6, “time” in the table 302).

Subsequently, the camera switching information generation unit 152 generates reference camera switching information in which information obtained by associating the camera identification information, the photographing time information, and the target information is arranged in time series. Specifically, the camera switching information generation unit 152 generates reference camera switching information (in the example shown in FIG. 6, the table 302) in which information obtained by associating camera identification information (in the example illustrated in FIG. 6, “camera ID” in the table 302) capable of identifying each of the two or more different cameras, photographing time information (in the example illustrated in FIG. 6, “time” in the table 302) indicating photographing time at which each of the two or more items of different moving image information is photographed by each of the two or more different cameras, and target information related to a photographing target (in the example illustrated in FIG. 6, characters such as “Vocalist” and “Guitarist” in the table 302) included in each of the two or more items of different moving image information is arranged in time series.

When generating the reference camera switching information, the camera switching information generation unit 152 stores the generated reference camera switching information in the reference camera switching information database 300.

(Acquisition Unit 153)

The acquisition unit 153 acquires an editing target moving image to be edited. Specifically, the acquisition unit 153 acquires the editing target moving image from the video database 200. For example, the reception unit 151 receives a designation operation of an editing target moving image from the user via the input unit 120. When the reception unit 151 receives the designation operation of the editing target moving image, the acquisition unit 153 acquires the editing target moving image designated by the user from the video database 200. For example, the acquisition unit 153 acquires an editing target moving image (for example, a video of a music live show) including music information.

In addition, the acquisition unit 153 acquires reference camera switching information. Specifically, the acquisition unit 153 acquires the reference camera switching information from the reference camera switching information database 300. For example, the acquisition unit 153 acquires the reference camera switching information determined by the determination unit 154 to have high compatibility with the editing target moving image.

(Determination Unit 154)

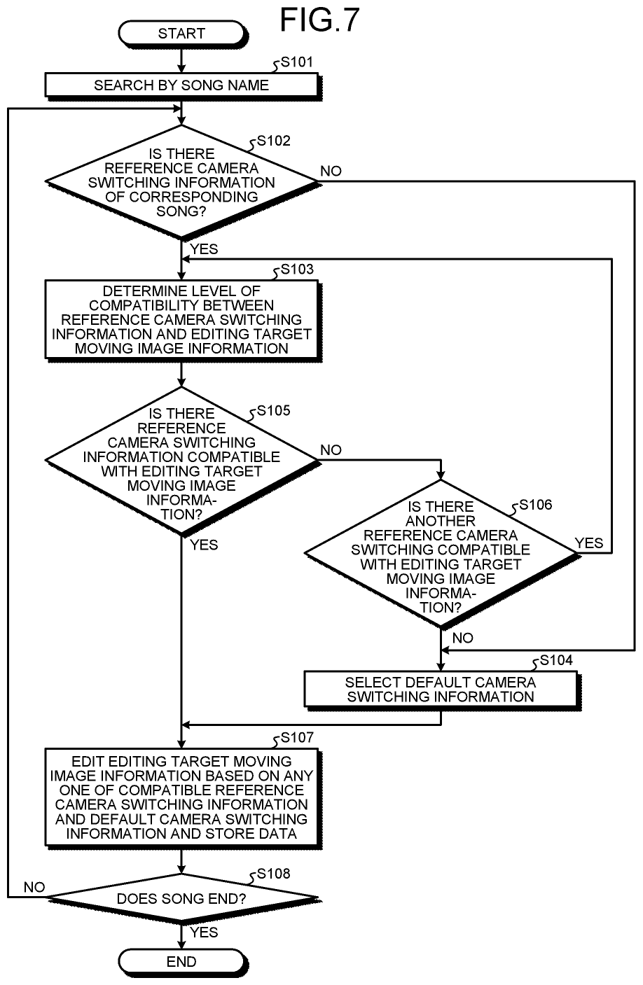

The determination unit 154 determines the level of compatibility between the editing target moving image and the reference camera switching information. FIG. 7 is a flowchart illustrating an example of determination processing of determining a level of compatibility between reference camera switching information and an editing target moving image according to the embodiment of the present disclosure. In FIG. 7, a case where the editing target moving image is a video of a music live show is described. First, when the acquisition unit 153 acquires the editing target moving image, the determination unit 154 extracts a song name associated with the editing target moving image. Subsequently, after extracting the song name, the determination unit 154 determines to search for reference camera switching information associated with the same song name as the extracted song name (Step S101).

When determining to search with the song name, the determination unit 154 refers to the reference camera switching information database 300 and determines whether there is reference camera switching information associated with the same song name as the song name associated with the editing target moving image (Step S102).

When determining that there is the reference camera switching information associated with the same song name as the song name associated with the editing target moving image (Step S102; Yes), the determination unit 154 determines the level of compatibility between the reference camera switching information associated with the same song name as the song name associated with the editing target moving image and the editing target moving image (Step S103). Specifically, the determination unit 154 generates the camera work information related to the editing target moving image by performing processing similar to generation processing of the reference camera switching information by the camera switching information generation unit 152 on the editing target moving image.

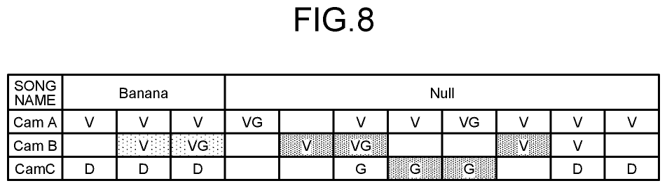

For example, the determination unit 154 generates the camera work information represented by the table illustrated in FIG. 8. FIG. 8 is a diagram illustrating an example of the camera work information related to the editing target moving image according to the embodiment. The first row of the table illustrated in FIG. 8 indicates song names of “Banana” and “Null” of two pieces of music included in the editing target moving image. In addition, the arrangement order of the song names corresponds to the time when the video corresponding to the song name is photographed. The first row of the table illustrated in FIG. 8 indicates that a video corresponding to the song name “Banana” is photographed and then a video corresponding to the song name “Null” is photographed.

In addition, the first column of the table illustrated in FIG. 8 indicates that there are three cameras of “Cam A”, “Cam B”, and “Cam C” that photograph videos corresponding to song names. That is, the first column of the table illustrated in FIG. 8 indicates that the editing target moving image is configured by three types of moving image information photographed from different angles by the three cameras of “Cam A”, “Cam B”, and “Cam C”.

In the example illustrated in FIG. 8, the determination unit 154 performs image analysis on the video of each of the two song names of “Banana” and “Null” associated with the editing target moving image. Subsequently, as an example of the camera work information related to the editing target moving image, the determination unit 154 generates a table in which a pattern of the time transition of the camera work and a pattern of the time transition of the characters in the videos of the two song names of “Banana” and “Null” are associated with each other. For example, characters “V” in the table illustrated in FIG. 8 indicate that a character “Vocalist” appears in the video at that time. Similarly, “G” indicates that the character “Guitarist” appears in the video, and “D” indicates that the character “Drummer” appears in the video. This time, attribute classification by a musical instrument such as a vocal or a guitar is exemplified, but the classification may be performed by a unique name, a position, or the like of each individual other than this classification.

Subsequently, when generating the camera work information related to the editing target moving image, the determination unit 154 calculates a compatibility degree between the generated camera work information and the reference camera switching information. For example, the determination unit 154 determines whether the pattern of time transition of the camera work and the characters which is the same as the pattern of time transition of the camera work and the characters in the reference camera switching information shown in the table 302 of FIG. 6 exists in the table shown in FIG. 8. For example, the determination unit 154 compares the pattern of the time transitions of the camera work and the characters in the reference camera switching information shown in the table 302 in FIG. 6 with the table shown in FIG. 8 and determines whether the pattern of the time transitions of the camera work and the characters which is the same as the pattern of the time transitions of the camera work and the characters in the reference camera switching information shown in the table 302 in FIG. 6 exists in the table shown in FIG. 8.

In FIG. 8, the determination unit 154 determines that the pattern of the time transition of the camera work and the characters indicated by the black dot pattern of the song name “Null” in the table illustrated in FIG. 8 is the same as the pattern of the time transition of the camera work and the characters in the reference camera switching information illustrated in the table 302 in FIG. 6. When determining that the pattern of time transition of the camera work and the characters which is the same as the pattern of time transition of the camera work and the characters in the reference camera switching information shown in the table 302 of FIG. 6 exists in the table shown in FIG. 8, the determination unit 154 determines that compatibility between the reference camera switching information and the editing target moving image is high.

The pattern of the time transition of the camera work and the characters shown in the table of FIG. 8 is as follows. First, it is indicated that a video of “VG (vocalist and guitarist)” is photographed following the video of “V (vocalist)” by the camera indicated by “Cam B”. Next, it is illustrated that the video of “G (Guitarist)” is continuously photographed following the video of “G (Guitarist)” by the camera indicated by “Cam C”. Next, it is indicated that the video of “V (vocalist)” is photographed by the camera indicated by “Cam B”. Note that, for the last transition from “Cam C” to “Cam B”, it is also possible to select the transition from “Cam C” to “Cam A”, but the determination unit 154 selects the transition from “Cam C” to “Cam B” having higher compatibility based on the comparison result such as the occupancy rate of the angle of view described above.

Subsequently, the determination unit 154 determines that the pattern (the pattern indicating that the video of “VG (vocalist and guitarist)” is photographed following the video of “V (vocalist)” by the camera indicated by “Cam B”) of the time transition of the camera work and the characters shown in the black dot pattern of the song name of “Banana” in the table illustrated in FIG. 8 is the same as the first half pattern (the pattern indicating that the video of “Vocalist” and “Guitarist” is photographed following the video of “Vocalist” which is the character by the camera identified by “Cam 1”) of the time transition of the camera work and the characters in the reference camera switching information illustrated in the table 302 in FIG. 6. However, since the two song names are different from each other, the determination unit 154 determines to compare the song name of “Banana” with the reference camera switching information having the same song name.

When there is no reference camera switching information having the same song name, the determination unit 154 may determine the level of compatibility with reference camera switching information having different song names. In addition, the determination unit 154 may determine the level of compatibility with the reference camera switching information of the same song of the user having a similar attribute to the attribute of the user. In addition, the determination unit 154 may determine the level of compatibility by combining a plurality of items of reference camera switching information. For example, the determination unit 154 may dynamically switch the reference camera switching information for determining the level of compatibility between the first half and the second half in the same song.

The description returns to FIG. 7. The determination unit 154 determines whether the reference camera switching information compatible with the editing target moving image exists (Step S105). For example, the determination unit 154 determines the level of compatibility between the editing target moving image and the reference camera switching information and determines that there is the reference camera switching information compatible with the editing target moving image when the reference camera switching information determined to have high compatibility with the editing target moving image exists. Meanwhile, when reference camera switching information determined to have high compatibility with the editing target moving image does not exist, the determination unit 154 determines that the reference camera switching information compatible with the editing target moving image does not exist.

(Video Generation Unit 155)

The video generation unit 155 generates the edited moving image which is the editing target moving image that is edited based on the reference camera switching information determined to have high compatibility by the determination unit 154. In FIG. 7, when the determination unit 154 determines that the reference camera switching information that is compatible with the editing target moving image exists (Step S105; Yes), the video generation unit 155 edits the editing target moving image based on the reference camera switching information compatible with the editing target moving image. In this manner, the video generation unit 155 generates the edited moving image, which is the editing target moving image that is edited based on the reference camera switching information. After generating the edited moving image, the video generation unit 155 stores the generated edited moving image in the storage unit 140 (Step S107).

After storing the generated edited moving image in the storage unit 140, the determination unit 154 determines whether the song in the editing target moving image ends (Step S108). When the determination unit 154 determines that the song ends (Step S108; Yes), the processing ends. Meanwhile, when the determination unit 154 determines that the song does not end (Step S108; No), the processing of Step S102 is repeated.

Meanwhile, when determining that the reference camera switching information associated with the same song name as the song name associated with the editing target moving image does not exist (Step S102; No), the determination unit 154 selects the default camera work information (Step S104). When the determination unit 154 selects the default camera work information, the video generation unit 155 edits the editing target moving image based on the default camera work information. In this manner, the video generation unit 155 generates the edited moving image, which is the editing target moving image that is edited based on the default camera work information. After generating the edited moving image, the video generation unit 155 stores the generated edited moving image in the storage unit 140 (Step S107). Note that, for the default information, the video generation unit 155 may refer to preset information on the distributor side, may refer to setting information of users having close user attributes or the user's own information in the past, or may generate a combination thereof.

On the other hand, when determining that the reference camera switching information compatible with the editing target moving image does not exist (Step S105; No), the determination unit 154 determines whether there is another item of the reference camera switching information that is compatible with the editing target moving image (Step S106). When the determination unit 154 determines that there is another item of the reference camera switching information that is compatible with the editing target moving image (Step S106; Yes), the processing of Step S103 is repeated. Meanwhile, when the determination unit 154 determines that there is no other item of the reference camera switching information that is compatible with the editing target moving image (Step S106; No), the default camera work information is selected (Step S104). When the determination unit 154 selects the default camera work information, the video generation unit 155 edits the editing target moving image based on the default camera work information to generate the edited moving image, and stores the generated edited moving image in the storage unit 140 (Step S107).

Generally, in a music live show, switching timing often matches with timing of a beat of music or the like. Therefore, when editing the editing target moving image by using the reference camera switching information, the video generation unit 155 may detect the beat of the editing target moving image and adjust the switching timing in the editing. For example, the video generation unit 155 may consider, as the timing to consider, timing of performance such as a special effect, choreography switching, phrase switching of performance, and the like in addition to the beat.

(Output Control Unit 156)

An output control unit 156 performs control to output the moving image information on the output unit 130. The output control unit 156 performs control so that the moving image information is displayed on the screen. For example, the output control unit 156 causes the edited moving image generated by the video generation unit 155 to be displayed on the screen.

(Transmission Unit 157)

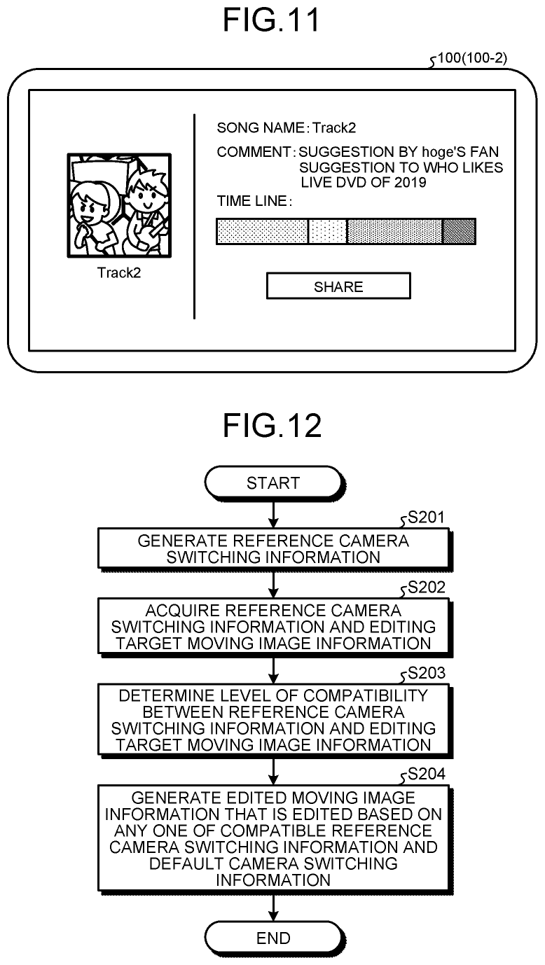

The transmission unit 157 transmits the edited moving image generated by the video generation unit 155 to another information processing apparatus. The other information processing apparatus may be an external server device or an information processing apparatus 100 of another user. In FIG. 11, a case where the transmission unit 157 transmits the edited moving image generated by the video generation unit 155 to the information processing apparatus 100 of another user is described. FIG. 11 is a diagram illustrating an example of a screen of a user interface for sharing the edited moving image according to the embodiment of the present disclosure with another user. As illustrated in FIG. 11, the output control unit 156 may display an outline of the composition as a timeline in addition to the comment. Note that this outline may be used as attribute information as a search target.

[4. Information Processing Procedure]

FIG. 12 is a flowchart illustrating an example of information processing by the information processing apparatus 100 according to the embodiment of the present disclosure. As illustrated in FIG. 12, the camera switching information generation unit 152 of the information processing apparatus 100 generates reference camera switching information (Step S201). The acquisition unit 153 of the information processing apparatus 100 acquires the reference camera switching information and the editing target moving image (Step S202). The determination unit 154 of the information processing apparatus 100 determines the level of compatibility between the reference camera switching information and the editing target moving image (Step S203). The video generation unit 155 of the information processing apparatus 100 generates the edited moving image that is edited based on either the reference camera switching information determined to have high compatibility by the determination unit 154 or the default camera switching information (Step S204).

[5. Modification]

The information processing system 1 according to the above-described embodiment may be implemented in various different modes other than the above-described embodiment. Therefore, another embodiment of the information processing system 1 is described below. The same parts as those in the embodiment are denoted by the same reference numerals, and the description thereof is omitted.

For example, the transmission unit 157 may transmit the reference camera switching information generated by the camera switching information generation unit 152 to another information processing apparatus. Furthermore, the acquisition unit 153 acquires the reference camera switching information selected by another user and the editing target moving image to be edited from among a plurality of items of reference camera switching information output to another information processing apparatus. The video generation unit 155 generates the edited moving image which is the editing target moving image that is edited based on the reference camera switching information selected by the another user.

In addition, the video generation unit 155 may not perform editing reflecting the preference of the user on all the editing target moving images. For example, the camera work may be fixed to a fixed camera work according to a performance intention on the performer side. In such a case, an uncorrectable flag may be set in advance.

Further, as in live streaming, in real time or in a case equivalent thereto, by uploading the reference camera switching information to the processing server or the like in advance, the edited data may be distributed according to the reference camera switching information at the time of streaming. Meanwhile, in the case of non-real-time distribution, presentation may be performed to the user in a temporary editing stage in advance, and additional editing of the user may be added.

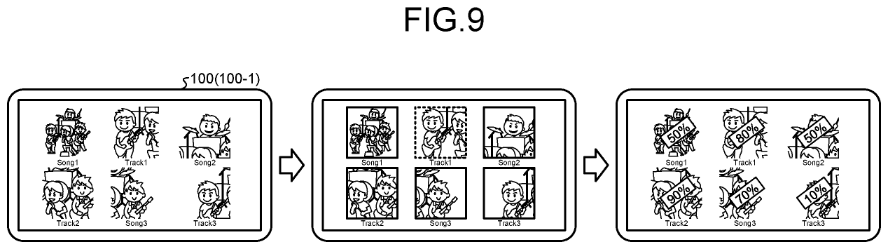

Furthermore, in the case of real-time distribution, in order to ensure the distribution quality on the distributor side, pre-filtering may be performed on videos with poor quality or videos that do not match the concept of the performer before comparison with reference data. In addition, as the reference camera switching information, processing of invalidating the tagging when generating the reference camera switching information, excluding the portion, or the like may be performed for the cut that damages the feeling or the public image of the performer. At that time, for example, as illustrated in FIG. 9, the output control unit 156 displays the thumbnail of each piece of music of the edited moving image in a tile shape. FIG. 9 is a diagram illustrating an example of a screen of a user interface that displays the edited moving image according to the embodiment of the present disclosure. The output control unit 156 selects and displays, as the thumbnail, a thumbnail close to a more “Like” composition in the music by the user, an object near a hook, or the like. In addition, the output control unit 156 may notify, by display, that the change processing cannot be performed and that the change processing can be performed according to the intention of the performer side. In addition, the output control unit 156 may display the compatibility degree with the reference camera switching information as a numerical value or batch. The output control unit 156 may display the summary moving image of the edited moving image in addition to the tile display. For example, the output control unit 156 may generate and display a summary version for the edited moving image by displaying a hook, a beginning, or the like of each piece of music.

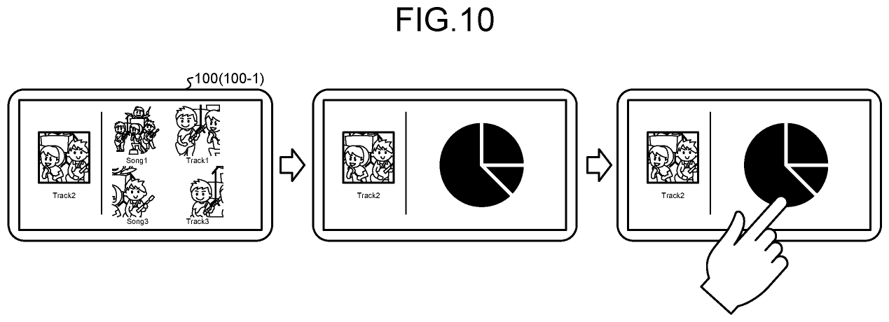

When the user partially changes the edited moving image, the output control unit 156 may select music to be changed and display a moving image of another editing of the same music as a candidate. FIG. 10 is a diagram illustrating an example of a screen of a user interface for editing the edited moving image according to the embodiment of the present disclosure. In FIG. 10, the output control unit 156 displays a circular graph indicating composition information and an appearance ratio for each performer next to the thumbnail of the edited moving image. For example, when the user performs an operation of changing the ratio of the circular graph on the screen, the reception unit 151 receives the operation of the user. The camera switching information generation unit 152 corrects the reference camera switching information based on the operation received by the reception unit 151. The video generation unit 155 further edits the edited moving image based on the corrected reference camera switching information. In this manner, the video generation unit 155 generates the edited moving image that is further edited based on the corrected reference camera switching information. Note that the output control unit 156 may directly display the analysis result as illustrated in FIG. 8, and the user may directly change the analysis result.

Next, an example of utilization in sports is described. Similarly, in the case of sports, the user performs tagging or the like and generates the reference camera switching information. On the other hand, in many sports, there are scenes to be prioritized, such as a scoring scene and a knockout scene, and scenes that can be shortened, such as a change and a balanced state. In addition, since there are many angles of view in a fixed scene as the angle of view of the camera, it is difficult to determine editing with only the angle of view. Therefore, at the time of editing, by editing mainly the scene to be prioritized, temporal compression (cutting, double speed reproduction, or the like) and sharpness of the edited content may be imparted.

[6. Effects]

As described above, the information processing apparatus 100 according to the embodiment or the modification of the present disclosure includes the output unit 130. Here, the output unit 130 outputs the reference camera switching information for continuously reproducing a first moving image obtained by capturing an image of a first target by a first camera and a second moving image obtained by capturing an image of a second target related to the first target by a second camera different from the first camera according to an input operation of the user.

In this manner, the information processing apparatus 100 generates the reference camera switching information based on the camera work that suits the user's own taste selected by the user in advance from among the video contents viewed in the past. As a result, even when there are images photographed by a plurality of cameras with respect to the same sound source like a music live show, the information processing apparatus 100 can appropriately select an image of a camera that suits the preference of the user based on the reference camera switching information from among the images photographed by the plurality of cameras. Furthermore, the information processing apparatus 100 can edit video according to the reference camera switching information when the user views new video content. Therefore, the information processing apparatus 100 can generate a video that suits the preference of the user without disturbing the video experience of the user. That is, the information processing apparatus 100 can improve usability in the moving image editing service.

Further, the reference camera switching information is information including camera identification information capable of identifying the first camera and the second camera and photographing time information indicating photographing time at which the first moving image and the second moving image are respectively photographed. The reference camera switching information is information including first target information that is information related to a first target and second target information that is information related to a second target.

As a result, the information processing apparatus 100 enables editing of the editing target moving image based on a camera work or switching that suits the preference of the user.

The first target information includes identification information for identifying the first target and information related to position coordinates of the first target in the angle of view, an occupied area of the first target, and position coordinates of each part of the first target, and the second target information includes identification information for identifying the second target and information related to position coordinates of the second target in the angle of view, an occupied area of the second target, and position coordinates of each part of the second target.

As a result, the information processing apparatus 100 enables editing of the editing target moving image based on the appearance pattern of the photographing target (for example, the characters) that suits the preference of the user.

Furthermore, the information processing apparatus 100 further includes the acquisition unit 153, the determination unit 154, and the video generation unit 155. The acquisition unit 153 acquires an editing target moving image to be edited and the reference camera switching information. The determination unit 154 determines the level of compatibility between the editing target moving image and the reference camera switching information. The video generation unit 155 generates the edited moving image which is the editing target moving image that is edited based on the reference camera switching information determined to have high compatibility by the determination unit 154.

As a result, the information processing apparatus 100 selects the reference camera switching information having high compatibility with the editing target moving image and enables editing of the editing target moving image based on the reference camera switching information having high compatibility with the editing target moving image.

Furthermore, the information processing apparatus 100 further includes a transmission unit 157. The transmission unit 157 transmits the edited moving image generated by the video generation unit 155 to another information processing apparatus.

As a result, the information processing apparatus 100 enables sharing of the edited moving image between fans or the like.

Furthermore, the transmission unit 157 transmits the reference camera switching information output by the output unit 130 to another information processing apparatus. Furthermore, the acquisition unit 153 acquires the reference camera switching information selected by another user and the editing target moving image to be edited from among a plurality of items of reference camera switching information output to another information processing apparatus of the other user. The video generation unit 155 generates the edited moving image which is the editing target moving image that is edited based on the reference camera switching information selected by the another user.

As a result, the information processing apparatus 100 enables sharing of the reference camera switching information between fans or the like.

Furthermore, the video generation unit 155 generates the edited moving image according to whether the moving image is distributed simultaneously with the photographing of the moving image.

Therefore, for example, as in live streaming, in real time or in a case equivalent thereto, by uploading the reference camera switching information to the processing server or the like in advance, the information processing apparatus 100 can distribute the edited data according to the reference camera switching information at the time of streaming.

Further, the video generation unit 155 generates the edited moving image excluding the video preset by the performer.

As a result, the information processing apparatus 100 can generate the edited moving image reflecting the performance intention on the performer side.

Furthermore, the video generation unit 155 generates the edited moving image based on the beat of the music included in the editing target moving image, the timing of the performance switching, the timing of the choreography switching, or the timing of the performance phrase switching.

As a result, the information processing apparatus 100 can generate the edited moving image at an appropriate timing.

Furthermore, the information processing apparatus 100 further includes a camera switching information generation unit 152 that generates reference camera switching information. The camera switching information generation unit 152 generates the reference camera switching information based on the camera work selected by the user from among the video content viewed by the user in the past. The output unit 130 outputs the reference camera switching information generated by the camera switching information generation unit 152.

As a result, the information processing apparatus 100 can generate the reference camera switching information reflecting the preference of the user.

The camera switching information generation unit 152 performs image analysis on an input section that is a section of a moving image input by the user, detects target information related to a photographing target appearing in the input section and an appearance time of the photographing target, and generates reference camera switching information based on the detected target information and the detected appearance time. In general, even in a state of the same appearance,

the value as the video representation is different between the drawing and the zooming, but the drawing and the zooming can be performed. Meanwhile, the information processing apparatus 100 can generate reference camera switching information reflecting a camera work such as the drawing and the zooming.

The camera switching information generation unit 152 generates the reference camera switching information based on the camera work determined by the performance intention of the performer.

As a result, the information processing apparatus 100 can generate the reference camera switching information reflecting the performance intention of the performer.

The camera switching information generation unit 152 invalidates the user's input operation for a cut that damages the feeling or the public image of the performer and generates the reference camera switching information.

As a result, the information processing apparatus 100 can generate the reference camera switching information that does not include a cut that damages the feeling or the public image of the performer.

Furthermore, the information processing apparatus 100 further includes the output control unit 156 that performs control to output the edited moving image on the output unit 130. The output control unit 156 generates a summary of the edited moving image and performs control to output the generated summary on the output unit 130. The output unit 130 outputs the summary.

As a result, the information processing apparatus 100 can make it easy for the user to select a desired edited moving image from among the plurality of edited moving images.

The output unit 130 outputs the reference camera switching information based on a scene of a moving image in sports.

Therefore, the information processing apparatus 100 can output the reference camera switching information based on a scene of a moving image in sports.

[7. Hardware Configuration]

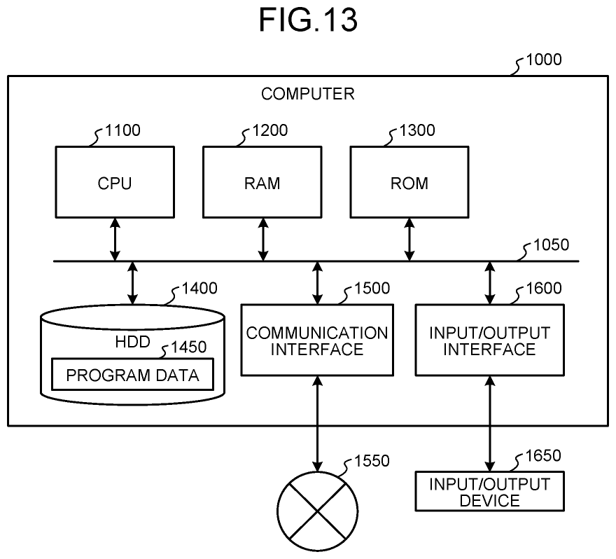

The information apparatus such as the information processing apparatus 100 according to the above-described embodiment is reproduced by a computer 1000, for example, having a configuration as illustrated in FIG. 13. FIG. 13 is a hardware configuration diagram illustrating an example of the computer 1000 that reproduces functions of the information processing apparatus such as the information processing apparatus 100. Hereinafter, the information processing apparatus 100 according to the embodiment is described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400 and controls each unit. For example, the CPU 1100 loads the program stored in the ROM 1300 or the HDD 1400 into the RAM 1200 and executes processing corresponding to various programs.

The ROM 1300 stores a boot program such as a basic input output system (BIOS) executed by the CPU 1100 at the time of activating the computer 1000, a program depending on hardware of the computer 1000, and the like.

The HDD 1400 is a computer-readable recording medium that records a program executed by the CPU 1100, data used by the program, and the like in a non-transitory manner. Specifically, the HDD 1400 is a recording medium that records a program according to the present disclosure which is an example of a program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the information processing apparatus 100 according to the embodiment, the CPU 1100 of the computer 1000 reproduces the functions of the control unit 140 and the like by executing a program loaded onto the RAM 1200. In addition, the HDD 1400 stores a program according to the present disclosure and various kinds of data. Note that the CPU 1100 reads the program data 1450 from the HDD 1400 and executes the program data, but as another example, these programs may be acquired from another device via the external network 1550.

Furthermore, the effects described in the present specification are merely illustrative or exemplary and are not restrictive. That is, the technology according to the present disclosure can exhibit other effects obvious to those skilled in the art from the description of the present specification together with or instead of the above effects.

Note that the present technology can also have the following configurations.

(1)

Information processing apparatus including:
an output unit that outputs reference camera switching information for continuously reproducing a first moving image obtained by capturing an image of a first target by a first camera and a second moving image obtained by capturing an image of a second target related to the first target by a second camera different from the first camera according to an input operation of a user.
   (2)

The information processing apparatus according to (1),
wherein the reference camera switching information is information including camera identification information capable of identifying the first camera and the second camera and photographing time information indicating photographing time at which the first moving image and the second moving image are respectively photographed.
   (3)

The information processing apparatus according to (2),
wherein the reference camera switching information is information including first target information that is information related to the first target and second target information that is information related to the second target.
   (4)

The information processing apparatus according to (3),
wherein the first target information includes identification information for identifying the first target and information related to position coordinates of the first target in an angle of view, an occupied area of the first target, and position coordinates of each part of the first target, and the second target information includes identification information for identifying the second target and information related to position coordinates of the second target in an angle of view, an occupied area of the second target, and position coordinates of each part of the second target.
   (5)

The information processing apparatus according to (1), further including:
an acquisition unit that acquires an editing target moving image to be edited and the reference camera switching information;
a determination unit that determines a level of compatibility between the editing target moving image and the reference camera switching information; and
a video generation unit that generates an edited moving image which is the editing target moving image that is edited based on the reference camera switching information determined to have high compatibility by the determination unit.
   (6)

The information processing apparatus according to (5), further including:
a transmission unit that transmits the edited moving image generated by the video generation unit to another information processing apparatus.
   (7)

The information processing apparatus according to (6),
wherein the transmission unit transmits the reference camera switching information output by the output unit to the other information processing apparatus.
   (8)

The information processing apparatus according to (1), further including:
a transmission unit that transmits the reference camera switching information output by the output unit to another information processing apparatus.
   (9)

The information processing apparatus according to (7), further including:
an acquisition unit that acquires the reference camera switching information selected by another user and an editing target moving image to be edited from among a plurality of items of the reference camera switching information output to the another information processing apparatus of the another user; and
a video generation unit that generates an edited moving image which is the editing target moving image that is edited based on the reference camera switching information selected by the another user.
   (10)

The information processing apparatus according to (5),
wherein the video generation unit generates the edited moving image according to whether the moving image is distributed simultaneously with the photographing of the moving image.
   (11)

The information processing apparatus according to (5),
wherein the video generation unit generates the edited moving image excluding a video preset by a performer.
   (12)

The information processing apparatus according to (5),
wherein the video generation unit generates the edited moving image based on a beat of music included in the editing target moving image, a timing of performance switching, a timing of choreography switching, or a timing of performance phrase switching.
   (13)

The information processing apparatus according to (1), further including:
a camera switching information generation unit that generates the reference camera switching information,
wherein the camera switching information generation unit generates the reference camera switching information based on a camera work selected by the user from among a video content viewed by the user in the past, and
the output unit outputs the reference camera switching information generated by the camera switching information generation unit.
   (14)

The information processing apparatus according to (13),
wherein the camera switching information generation unit performs image analysis on an input section that is a section of a moving image input by the user, detects target information related to a photographing target appearing in the input section and an appearance time of the photographing target, and generates the reference camera switching information based on the detected target information and the detected appearance time.
   (15)

The information processing apparatus according to (13),
wherein the camera switching information generation unit generates the reference camera switching information based on the camera work determined by a performance intention of a performer.
   (16)

The information processing apparatus according to (13),
wherein the camera switching information generation unit invalidates the user's input operation for a cut that damages a feeling or a public image of a performer and generates the reference camera switching information.
   (17)

The information processing apparatus according to (5), further including:
an output control unit that performs control to output the edited moving image on the output unit,
wherein the output control unit generates a summary of the edited moving image and performs control to output the generated summary on the output unit, and
the output unit outputs the summary.
   (18)

The information processing apparatus according to (1),
wherein the output unit outputs the reference camera switching information based on a scene of a moving image in sports.
   (19)

An information processing method executed by a computer, the method including:
an outputting step of outputting reference camera switching information for continuously reproducing a first moving image obtained by capturing an image of a first target by a first camera and a second moving image obtained by capturing an image of a second target related to the first target by a second camera different from the first camera according to an input operation of a user input by the user.
   (20)

A non-transitory computer-readable storage medium that stores information processing program that causes a computer to execute:
an outputting procedure of outputting reference camera switching information for continuously reproducing a first moving image obtained by capturing an image of a first target by a first camera and a second moving image obtained by capturing an image of a second target related to the first target by a second camera different from the first camera according to an input operation of a user input by the user.

### REFERENCE SIGNS LIST

1 INFORMATION PROCESSING SYSTEM
100 INFORMATION PROCESSING APPARATUS
110 COMMUNICATION UNIT
120 INPUT UNIT
130 OUTPUT UNIT
140 STORAGE UNIT
150 CONTROL UNIT
151 RECEPTION UNIT
152 CAMERA SWITCHING INFORMATION GENERATION UNIT
153 ACQUISITION UNIT
154 DETERMINATION UNIT
155 VIDEO GENERATION UNIT
156 OUTPUT CONTROL UNIT
157 TRANSMISSION UNIT
200 VIDEO DATABASE
300 REFERENCE CAMERA SWITCHING INFORMATION DATABASE
400 STREAMING SERVER

1. Information processing apparatus including:
an output unit that outputs reference camera switching information for continuously reproducing a first moving image obtained by capturing an image of a first target by a first camera and a second moving image obtained by capturing an image of a second target related to the first target by a second camera different from the first camera according to an input operation of a user.

2. The information processing apparatus according to claim 1,
wherein the reference camera switching information is information including camera identification information capable of identifying the first camera and the second camera and photographing time information indicating photographing time at which the first moving image and the second moving image are respectively photographed.

3. The information processing apparatus according to claim 2,
wherein the reference camera switching information is information including first target information that is information related to the first target and second target information that is information related to the second target.

4. The information processing apparatus according to claim 3,
wherein the first target information includes identification information for identifying the first target and information related to position coordinates of the first target in an angle of view, an occupied area of the first target, and position coordinates of each part of the first target, and the second target information includes identification information for identifying the second target and information related to position coordinates of the second target in an angle of view, an occupied area of the second target, and position coordinates of each part of the second target.

5. The information processing apparatus according to claim 1, further including:
an acquisition unit that acquires an editing target moving image to be edited and the reference camera switching information;
a determination unit that determines a level of compatibility between the editing target moving image and the reference camera switching information; and
a video generation unit that generates an edited moving image which is the editing target moving image that is edited based on the reference camera switching information determined to have high compatibility by the determination unit.

6. The information processing apparatus according to claim 5, further including:
a transmission unit that transmits the edited moving image generated by the video generation unit to another information processing apparatus.

7. The information processing apparatus according to claim 6,
wherein the transmission unit transmits the reference camera switching information output by the output unit to the other information processing apparatus.

8. The information processing apparatus according to claim 1, further including:
a transmission unit that transmits the reference camera switching information output by the output unit to another information processing apparatus.

9. The information processing apparatus according to claim 7, further including:
an acquisition unit that acquires the reference camera switching information selected by another user and an editing target moving image to be edited from among a plurality of items of the reference camera switching information output to the another information processing apparatus of the another user; and
a video generation unit that generates an edited moving image which is the editing target moving image that is edited based on the reference camera switching information selected by the another user.

10. The information processing apparatus according to claim 5,
wherein the video generation unit generates the edited moving image according to whether the moving image is distributed simultaneously with the photographing of the moving image.

11. The information processing apparatus according to claim 5,
wherein the video generation unit generates the edited moving image excluding a video preset by a performer.

12. The information processing apparatus according to claim 5,
wherein the video generation unit generates the edited moving image based on a beat of music included in the editing target moving image, a timing of performance switching, a timing of choreography switching, or a timing of performance phrase switching.

13. The information processing apparatus according to claim 1, further including:
a camera switching information generation unit that generates the reference camera switching information,
wherein the camera switching information generation unit generates the reference camera switching information based on a camera work selected by the user from among a video content viewed by the user in the past, and
the output unit outputs the reference camera switching information generated by the camera switching information generation unit.

14. The information processing apparatus according to claim 13,
wherein the camera switching information generation unit performs image analysis on an input section that is a section of a moving image input by the user, detects target information related to a photographing target appearing in the input section and an appearance time of the photographing target, and generates the reference camera switching information based on the detected target information and the detected appearance time.

15. The information processing apparatus according to claim 13,
wherein the camera switching information generation unit generates the reference camera switching information based on the camera work determined by a performance intention of a performer.

16. The information processing apparatus according to claim 13,
wherein the camera switching information generation unit invalidates the user's input operation for a cut that damages a feeling or a public image of a performer and generates the reference camera switching information.

17. The information processing apparatus according to claim 5, further including:
an output control unit that performs control to output the edited moving image on the output unit,
wherein the output control unit generates a summary of the edited moving image and performs control to output the generated summary on the output unit, and
the output unit outputs the summary.

18. The information processing apparatus according to claim 1,
wherein the output unit outputs the reference camera switching information based on a scene of a moving image in sports.

19. An information processing method executed by a computer, the method including:
an outputting step of outputting reference camera switching information for continuously reproducing a first moving image obtained by capturing an image of a first target by a first camera and a second moving image obtained by capturing an image of a second target related to the first target by a second camera different from the first camera according to an input operation of a user input by the user.

20. A non-transitory computer-readable storage medium that stores information processing program that causes a computer to execute:
an outputting procedure of outputting reference camera switching information for continuously reproducing a first moving image obtained by capturing an image of a first target by a first camera and a second moving image obtained by capturing an image of a second target related to the first target by a second camera different from the first camera according to an input operation of a user input by the user.
